(19) United States
(12) Patent Application Publication
(10) Pub. No.: US 2024/0291348 A1
(43) Pub. Date: Aug. 29, 2024

(54) MAGNETIC LEVITATION MOTOR

(71) Applicant: Meng-Theng WANG, New Taipei City (TW)

(72) Inventor: Meng-Theng WANG, New Taipei City (TW)

(21) Appl. No.: 18/113,567

(22) Filed: Feb. 23, 2023

(51) Int. Cl. H02K 7/09; H02K 7/00

(52) U.S. Cl. CPC H02K 7/09; H02K 7/003

(57) ABSTRACT

A magnetic levitation motor includes a spindle arranged in a housing. Upper and lower ends of the spindle are respectively supported, in a suspended manner, by magnetic levitation bases. Further, a lateral surface of the spindle is supported by a number of magnetic levitation bearings. The spindle is further provided with a magnetic core mounted thereto to serve as a motor rotor. A winding that matches the magnetic core is arranged in the housing to serve as a stator of the motor. The present invention provides that the spindle is supported in a manner of full magnetic levitation, so that the rotation of the spindle has the lowest resistance to ensure a high power output.

### TECHNICAL FIELD OF THE INVENTION

The present invention relates generally to an electrical motor, and more particularly to a magnetic levitation motor.

### DESCRIPTION OF THE PRIOR ART

An electrical motor is generally made up of a rotor and a stator. The rotor is a rotating part, while the stator is a fixed, immobile part to provide a surrounding magnetic field. The principle of the motor is very similar to the principle of an electrical generator. Generally speaking, the electrical generator is operated by applying hydraulic power, thermal power, or power of other forms to rotate conductive wires (the rotor) in the magnetic field, in order to induce an electromotive force (voltage) in the conductive wires, while the motor is operated by receiving an external electrical power passing through the rotor or the stator to generate magnetic forces that act on each other to cause a spindle to rotate.

In a known motor, the spindle is arranged to couple to a housing by means of bearings. Although, generally, the bearings may be loaded with a lubricant preserved therein to reduce the frictional resistance, yet, to some extents, there is still a frictional force existing to make it hard to a power output efficiency for the motor.

### SUMMARY OF THE INVENTION

An objective of the present invention is to a motor that can greatly reduce the frictional resistance induced in the operation thereof so as to significantly enhance a motor power output efficiency for the motor.

The present invention provides a magnetic levitation motor, which comprises: a housing having an internal space; a lower magnetic levitation base, which is arranged at a bottom of the internal space; an upper magnetic levitation base, which is arranged at a top of the internal space; a plurality of magnetic levitation bearings, which are arranged in the internal space, respectively at different height-wise locations between the upper magnetic levitation base and the lower magnetic levitation base in a vertical direction; a spindle, which is arranged vertically on the magnetic levitation bearings in the internal space, upper and lower ends of the spindle being respectively connected to the upper magnetic levitation base and the lower magnetic levitation base, the upper end of the spindle being extended out of the housing; a magnetic core, which is arranged on the spindle to serve as a rotor of the motor; and a motor stator, which is arranged on an inner side of the housing and is formed of a winding and an iron ring, the iron ring facing the magnetic core. The magnetic levitation motor according to the present invention makes the spindle supported by the magnetic levitation bases and the magnetic levitation bearings so as to be kept in a non-contacted state, so that there is completely no frictional resistance induced during the rotation of the spindle, and thus, the power output efficiency is enhanced.

In an embodiment of the present invention, the lower magnetic levitation base can comprise: a lower stationary tray, which is fixed at the bottom of the internal space of the housing, a first magnet being arranged on an upper surface of the lower stationary tray; and a lower rotary tray, which is fixed to the lower end of the spindle, a second magnet being arranged on a lower surface of the lower rotary tray. The upper magnetic levitation base can comprise: an upper stationary tray, which is fixed at the top of the internal space of the housing, a first magnet being arranged on a lower surface of the upper stationary tray; and an upper rotary tray, which is fixed to the spindle, a second magnet being arranged on an upper surface of the upper rotary tray; wherein the first magnet and the second magnet are of the same magnetic polarity, so that mutual repulsion induced between the first magnet and the second magnet makes the upper rotary tray and the upper stationary tray, and also the lower rotary tray and the lower stationary tray, not contacting with each other.

In an embodiment of the present invention, the magnetic levitation bearings each comprise: a rotor, which comprises a plurality of fourth magnets arranged along an external circumference of the spindle; and a stator, which comprises a cylindrical body, which has an internal circumference along which a plurality of third magnets are arranged, the stator being fixed to the housing, such that the third magnets surround the fourth magnets, wherein the third magnets and the fourth magnets are of same magnetic polarity, so that mutual repulsion induced between the third magnets and the fourth magnets makes the spindle and the stator not contacting each other. By means of the magnetic levitation bearings and the upper and lower magnetic levitation bases, the spindle can be driven in a state of being held in a completely suspended condition, so that frictional resistance is completely eliminated.

The present invention provides a magnetic levitation motor in such a way that upper and lower ends of a spindle are respectively supported by an upper magnetic levitation base at an upper end of an interior of a housing and a lower magnetic levitation base at a lower end of the housing, and a magnetic repulsion force is induced on a lateral side of the spindle to support the spindle, so that the spindle, when driven to rotate, is completely kept in a suspended condition, without any frictional resistance induced thereon, and thus, the rotational speed of the spindle can be made faster, with extended period of time of persistence, thereby enhancing the power output efficiency.

### BRIEF DESCRIPTION OF THE DRAWINGS

FIG. 1 is a cross-sectional view, in a planar form, showing an embodiment of a magnetic levitation motor according to the present invention.

FIG. 2 is a cross-sectional view, in a planar form, taken along line II-II of FIG. 1.

FIG. 3 is a cross-sectional view, in a planar form, taken along line III-III of FIG. 1.

FIG. 4 is a cross-sectional view, in a planar form, taken along line IV-IV of FIG. 1.

FIG. 5 is a cross-sectional view, in a planar form, taken along line V-V of FIG. 1.

FIG. 6 is a cross-sectional view, in a planar form, taken along line VI-VI of FIG. 1.

### DETAILED DESCRIPTION OF THE PREFERRED EMBODIMENT

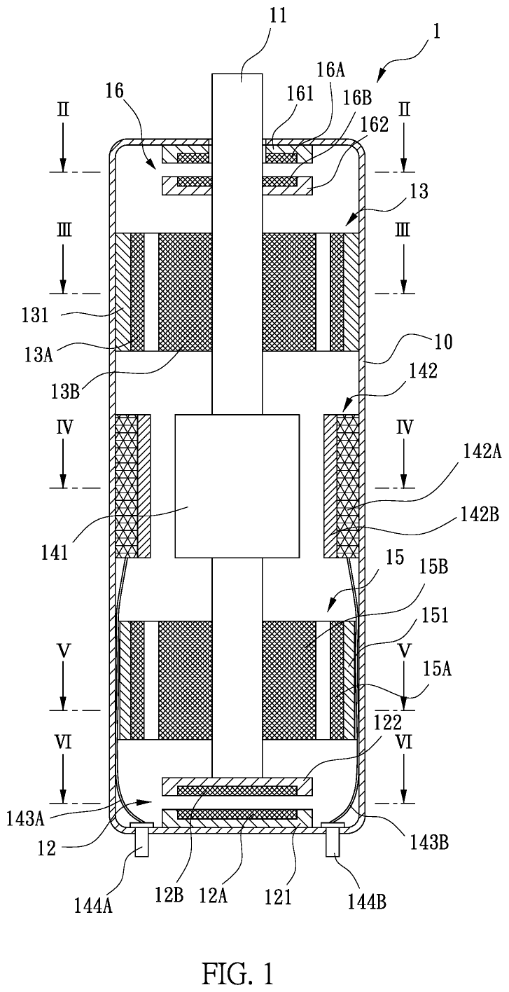

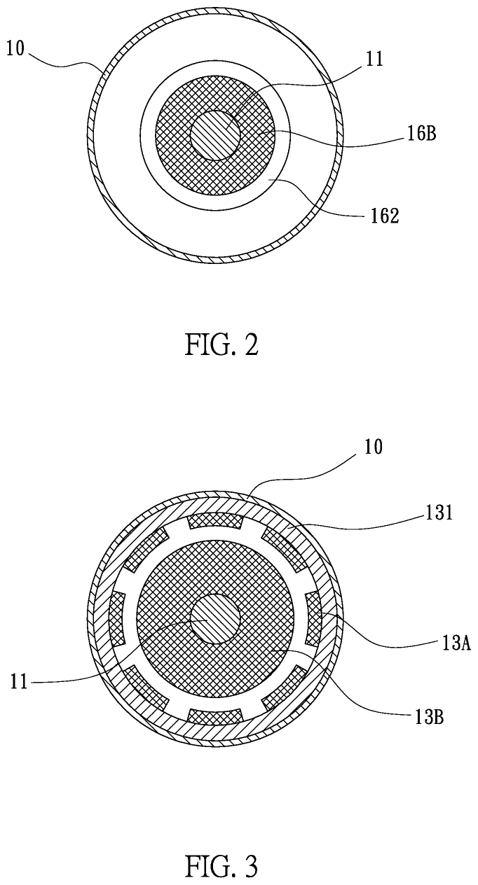

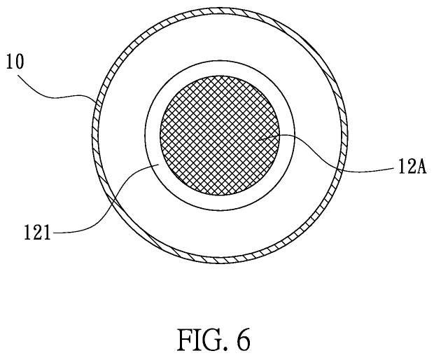

As shown in FIG. 1, the present invention provides, in an embodiment, a magnetic levitation motor 1, which comprises a housing 10 having an internal space. An upper magnetic levitation base 16 and a lower magnetic levitation base 12 are respectively arranged at top and bottom of the internal space. A first magnetic levitation bearing 13 and a second magnetic levitation bearing 15, which are of the same structure, are respectively arranged in the internal space at different height-wise positions in a vertical direction. As shown in FIGS. 1 and 2, the upper magnetic levitation base 16 is made up of an upper stationary tray 161 that is provided with a first magnet 16A mounted thereto and an upper rotary tray 162 that is provided with a second magnet 16B mounted thereto. The upper stationary tray 161 is fixed to a top surface inside the housing 10, and the upper rotary tray 162 is fixedly mounted to a spindle 11 inside the housing 10, so that the first magnet 16A and the second magnet 16B are opposite to each other and are not in contact with each other, and the first magnet 16A and the second magnet 16B are of the same magnetic polarity. Further, as shown in FIGS. 1 and 6, the lower magnetic levitation base 12 is made up of a lower stationary tray 121 that is provided with a first magnet 12A mounted thereto and a lower rotary tray 122 that is provided with a second magnet 12B mounted thereto. The lower stationary tray 121 is fixed to a bottom surface inside the housing 10, and the lower rotary tray 122 is fixed to a lower end of the spindle 11, so that the first magnet 12A and the second magnet 12B are opposite to each other and are not in contact with each other, and the first magnet 12A and the second magnet 12B are of the same magnetic polarity.

The present invention provides that the first magnetic levitation bearing 13 and the second magnetic levitation bearing 15 are respectively disposed at different locations of the spindle 11. As shown in FIGS. 1 and 3, the first magnetic levitation bearing 13 is formed of a first stator 131 and a first rotor and is arranged on an upper part of the spindle 11. The first stator 131 comprises a cylindrical body, which has an internal circumference along which a plurality of third magnets 13A are arranged. The first stator 131 is fixed to the housing 10. The first rotor is formed of a plurality of fourth magnets 13B, and the plurality of fourth magnets 13B are arranged along an external circumference of the spindle 11, such that the third magnets 13A surround the fourth magnets 13B, wherein the third magnets 13A and the fourth magnets 13B are of the same magnetic polarity. Therefore, the third magnets 13A that are arranged on the first stator 131 surround the fourth magnets 13B that are arranged on the spindle 11 such that a mutual repulsive force induced therebetween supports the spindle 11 in a sideway direction. Similarly, as shown in FIGS. 1 and 5, the second magnetic levitation bearing 15 is formed of a second stator 151 and a second rotor and is arranged on a lower part of the spindle 11. The second stator 151 comprises a cylindrical body, which has an internal circumference along which a plurality of third magnets 15A are arranged. The second stator 151 is fixed to the housing 10. The second rotor is formed of a plurality of fourth magnets 15B, and the plurality of fourth magnets 15B are arranged along the external circumference of the spindle 11, such that the third magnets 15A surround the fourth magnets 15B, wherein the third magnets 15A and the fourth magnets 15B are of the same magnetic polarity. Therefore, the third magnets 15A that are arranged on the second stator 151 surround the fourth magnets 15B that are arranged on the spindle 11 such that a mutual repulsive force induced therebetween supports the spindle 11 in a sideway direction. In other words, the first magnetic levitation bearing 13 and the second magnetic levitation bearing 15 that are respectively arranged on upper and lower parts of the spindle 11, and the upper suspension base 16 and the lower suspension base 12 that are respectively arranged at upper and lower ends of the spindle 11 hold and keep the spindle 11 in a suspended state.

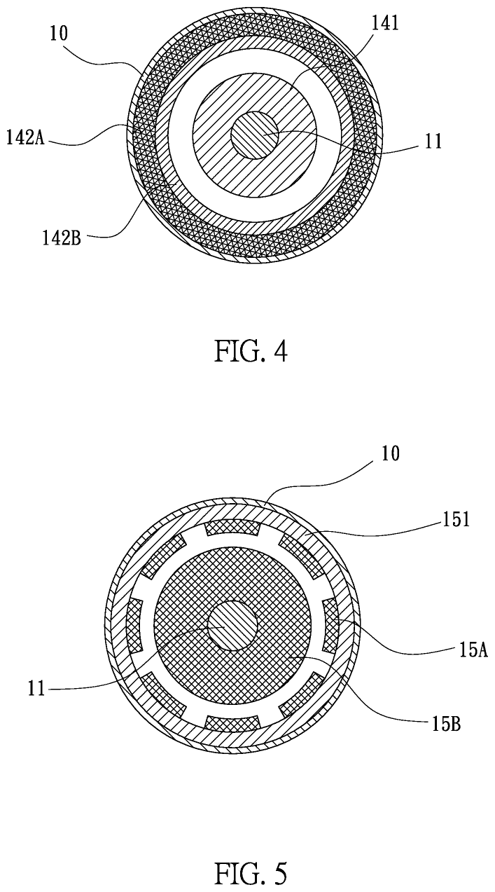

As shown in FIGS. 1 and 4, the present invention provides that a motor stator 142 and a motor rotor that function to drive the spindle 11 to rotate are arranged on the spindle 11 between the upper magnetic levitation bearing 13 and the lower magnetic levitation bearing 15, wherein the motor stator 142 is formed of a winding 142A that is fixedly mounted to an inner side of the housing 10 and an iron ring 142B arranged on an inner side of the winding 142A, and the winding 142A is electrically connected by two conductive wires 143A, 143B to a positive terminal 144A and a negative terminal 144B arranged at a bottom of the housing 10. The motor rotor comprises a magnetic core 141 fixed to the spindle 11. The magnetic core 141 and the winding 142A of the motor stator 142 generates induction magnetic fields toward each other.

The motor 1 according to the present invention, when supplied with an electrical current through the positive and negative terminals 144A, 144B, makes the winding 142 and the magnetic core 141 generate electromagnetic induction with respect to each other to drive the spindle 11 to rotate, and during the rotation of the spindle 11, the upper end and the lower end of the spindle 11 are respectively supported, in a suspended manner, by the upper magnetic levitation base 16 and the lower magnetic levitation base 12, and the spindle 11 is also supported, in the sideway direction, by the first magnetic levitation bearing 13 and the second magnetic levitation bearing 15, so that there is completely no frictional force induced by the spindle 11 during the rotation thereof and thus, the power output efficiency of the spindle 11 is enhanced.

I claim:

1. A magnetic levitation motor, comprising:
a housing, which has an internal space;
a lower magnetic levitation base, which is arranged at a bottom of the internal space;
an upper magnetic levitation base, which is arranged at a top of the internal space;
a plurality of magnetic levitation bearings, which are arranged in the internal space, respectively at different height-wise locations between the upper magnetic levitation base and the lower magnetic levitation base in a vertical direction;
a spindle, which is arranged vertically on the magnetic levitation bearings in the internal space, upper and lower ends of the spindle being respectively connected to the upper magnetic levitation base and the lower magnetic levitation base, the upper end of the spindle being extended out of the housing;
a magnetic core, which is arranged on the spindle to serve as a rotor of the motor; and
a motor stator, which is arranged on an inner side of the housing and is formed of a winding and an iron ring, the iron ring facing the magnetic core.

2. The magnetic levitation motor according to claim 1, wherein the lower magnetic levitation base comprises:
a lower stationary tray, which is fixed at the bottom of the internal space of the housing, a first magnet being arranged on an upper surface of the lower stationary tray; and
a lower rotary tray, which is fixed to the lower end of the spindle, a second magnet being arranged on a lower surface of the lower rotary tray; and
the upper magnetic levitation base comprises:
an upper stationary tray, which is fixed at the top of the internal space of the housing, a first magnet being arranged on a lower surface of the upper stationary tray; and
an upper rotary tray, which is fixed to the spindle, a second magnet being arranged on an upper surface of the upper rotary tray;
wherein the first magnet and the second magnet are of same magnetic polarity, so that mutual repulsion induced between the first magnet and the second magnet makes the upper rotary tray and the upper stationary tray, and also the lower rotary tray and the lower stationary tray, not contacting with each other.

3. The magnetic levitation motor according to claim 2, wherein each of the plurality of magnetic levitation bearings comprises:
a rotor, which comprises a plurality of fourth magnets arranged along an external circumference of the spindle; and
a stator, which comprises a cylindrical body, which has an internal circumference along which a plurality of third magnets are arranged, the stator being fixed to the housing, such that the third magnets surround the fourth magnets,
wherein the third magnets and the fourth magnets are of same magnetic polarity, so that mutual repulsion induced between the third magnets and the fourth magnets makes the spindle and the stator not contacting each other.
